(19) United States
(12) Patent Application Publication
(10) Pub. No.: US 2018/0163834 A1
(43) Pub. Date: Jun. 14, 2018

(54) DRIVE ASSEMBLY HAVING COMPOUND PLANETARY ARRANGEMENT

(71) Applicant: Caterpillar Inc., Peoria, IL (US)

(72) Inventors: Brian Charles BOGUSKI, Edwards, IL (US); Nathan Sean ENDERLE, East Peoria, IL (US); Anthony Ross JOHNSON, Washington, IL (US); Daniel J. MARQUETTE, JR., East Peoria, IL (US)

(73) Assignee: Caterpillar Inc., Peoria, IL (US)

(21) Appl. No.: 15/378,431

(22) Filed: Dec. 14, 2016

(51) Int. Cl. F16H 37/08; F16H 1/28

(52) U.S. Cl. CPC F16H 37/082; F16H 1/28

(57) ABSTRACT

A final drive is disclosed for use with a drive assembly of a mobile vehicle. The final drive may have a sun gear, a ring gear, and a plurality of planet gears. Each of the plurality of planet gears may have a large diameter portion configured to engage external teeth of the sun gear, and a small diameter portion configured to engage internal teeth of the ring gear. The final drive may also include a planet carrier operatively connected to each of the plurality of planet gears, and a plurality of bearings. The plurality of bearings may be disposed within the planet carrier and configured to support opposing ends of the plurality of planet gears.

### TECHNICAL FIELD

The present disclosure is directed to a drive assembly and, more particularly, to a drive assembly having a compound planetary arrangement.

### BACKGROUND

Machines, including on and off-highway haul and vocational trucks, wheel loaders, skid-steers, motor graders, and other types of heavy equipment generally include a mechanical transmission drivingly coupled to opposing traction devices by way of a differential and two substantially identical final drives (e.g., one final drive located between the differential and each traction device). The differential receives a power input from the transmission and produces two power outputs directed through the final drives to the traction devices. The final drives function to reduce an output rotational speed of the differential to a level appropriate to drive the associated traction devices and thereby propel the machine.

Each final drive generally includes an input shaft driven by the differential, an output shaft connected to the associated traction device, and a planetary gear arrangement connected between the input and output shafts. The planetary gear arrangement generally includes a sun gear fixed to rotate with the input shaft, a planet gear arrangement having a plurality of planet gears that are driven by the sun gear and a corresponding planet carrier fixed to rotate with the output shaft, and a stationary ring gear that also engages the planet gears. In most conventional configurations, three or four planet gears are used inside each planetary gear arrangement to transfer torque from the sun gear to the planet carrier. Although the conventional configuration may be suitable for some applications, it may be inadequate for other applications. In particular, in high-reduction applications, it can be difficult to package a 3- or 4-planet arrangement inside an associated housing due to the large sizes required of each planet gear.

One attempt to provide a compact high-reduction final drive is disclosed in JP Patent No. 5696450B2 (the '450 patent) of Nissan Motor Company that issued on Apr. 8, 2015. In particular, the '450 patent discloses a final drive having a planetary gear arrangement. The planetary gear arrangement includes a sun gear; four stepped planet gears each having a smaller gear portion engaged with the sun gear, and a larger gear portion placed axially adjacent the smaller gear portion; a planet carrier having a plurality of shafts, each shaft being configured to rotatably support one of the planet gears; a stationary ring gear engaged with the larger gear portions of the planet gears; and a wheel hub driven by the planet carrier and configured to rotationally support the sun gear and the ring gear.

Although the four-planet gear configuration described in the '450 patent may provide a high-reduction arrangement that could be adequate for some situations, it may also be problematic. Specifically, the four planet gears are supported on the planet carrier shafts via needle bearings. Because of uneven torque loading common in stepped planet gears, the needle bearings may tend to bind at their opposing ends. In addition, the needles within the bearings may be size-limited due to their location and, accordingly, have limited bearing capacity.

The drive assembly of the present disclosure is directed to overcoming one or more of the problems set forth above and/or other problems of the prior art.

### SUMMARY

One aspect of the present disclosure is directed to a final drive. The final drive may include a sun gear, a ring gear, and a plurality of planet gears. Each of the plurality of planet gears may have a large diameter portion configured to engage external teeth of the sun gear, and a small diameter portion configured to engage internal teeth of the ring gear. The final drive may also include a planet carrier operatively connected to each of the plurality of planet gears, and a plurality of bearings. The plurality of bearings may be disposed within the planet carrier and configured to support opposing ends of the plurality of planet gears.

Another aspect of the present disclosure is directed to another final drive. This final drive may include a sun gear, a ring gear, and at least four planet gears. The at least four planet gears may each have a large diameter portion configured to engage external teeth of the sun gear, and a small diameter portion configured to engage internal teeth of the ring gear. The final drive may also include a planet carrier operatively connected to each of the at least four planet gears. The planet carrier may have a base, a hub, and at least one fastener configured to connect the hub to the base. The final drive may further include a plurality of bearings disposed within the base and the hub of the planet carrier and configured to support the at least four planet gears.

In yet another aspect, the present disclosure is directed to a drive assembly. The drive assembly may include a differential having an input member, a traction device, an output member operatively connected to the traction device, and a final drive connected between the differential and the output member. The final drive may have a sun gear with a shaft connected to the differential, a stationary ring gear, and at least four planet gears. The at least four planet gears may each have a large diameter portion configured to engage external teeth of the sun gear, and a small diameter portion configured to engage internal teeth of the stationary ring gear. The final drive may also include a planet carrier operatively connected to each of the at least four planet gears. The planet carrier may have a base, a hub operatively connected to the output member, and at least one fastener configured to connect the hub to the base. The final drive may further include a plurality of cylindrical bearings disposed within the base and the hub of the planet carrier and configured to support opposing ends of the at least four planet gears. The sun gear, the at least four planet gears, the ring gear, and the plurality of bearings may be located axially between the base and the hub of the planet carrier.

### BRIEF DESCRIPTION OF THE DRAWINGS

FIG. 1 is an isometric illustration of an exemplary disclosed drive assembly;

FIG. 2 is an exploded view illustration of an exemplary final drive that forms a portion of the drive assembly of FIG. 1; and

FIG. 3 is schematic representation of an exemplary portion of the final drive of FIG. 2.

### DETAILED DESCRIPTION

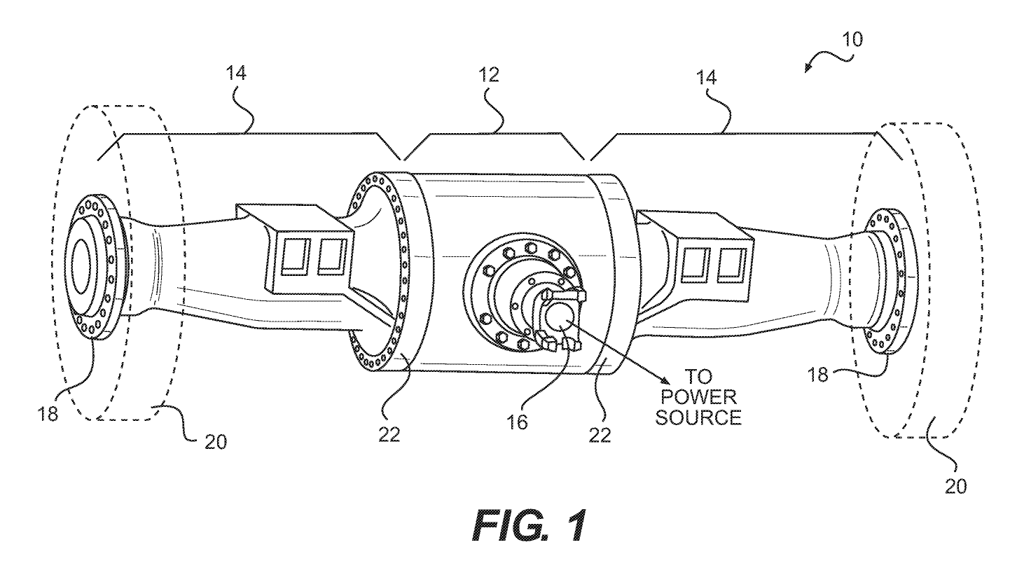

FIG. 1 illustrates an exemplary disclosed drive assembly 10. Drive assembly 10 may be associated with a mobile vehicle (not shown) so as to propel the vehicle. As such, drive assembly 10 may include a differential 12 operatively connected to one or more final drives 14. An input member 16 may drivingly connect a power source (e.g., an engine and/or transmission, an electric motor, a hydraulic motor, or another source) of the vehicle to differential 12. An output member 18 of each final drive 14 may drivingly connect to a corresponding traction device 20. In the disclosed embodiment, traction devices 20 embody wheels. It is contemplated, however, that traction devices 20 could alternatively embody tracks, belts, or other types of traction devices. Output member 18 of each final drive 14 may be drivingly coupled to differential 12 by way of a corresponding planetary gear arrangement 22, such that a rotation of input member 16 results in corresponding rotations of output members 18 and traction devices 20. In this way, output members 18 may be driven by differential 12 and speed-reduced by planetary gear arrangements 22.

For the purposes of this disclosure, a planetary gear arrangement may have at least three elements, including a sun gear, a planet carrier having at least one set of connected planet gears, and a ring gear. The planet gears of the planet carrier mesh with the sun gear and the ring gear. The sun gear, planet carrier, and planet gears all rotate simultaneously (although not necessarily at the same speeds and/or in the same directions), while the ring gear is held stationary. Each planetary gear arrangement receives one input rotation via the sun gear, and generates one corresponding output rotation via the planet carrier. The change in rotational speed between the input and the output rotations depends on the number of teeth in the sun gear, the planet gears, and the ring gear.

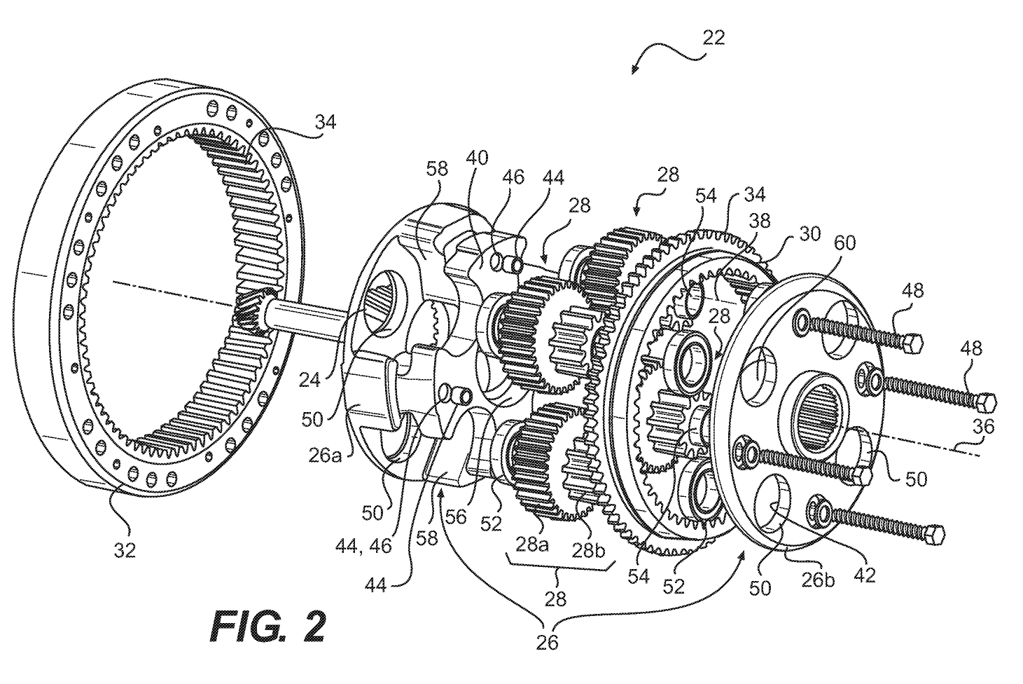

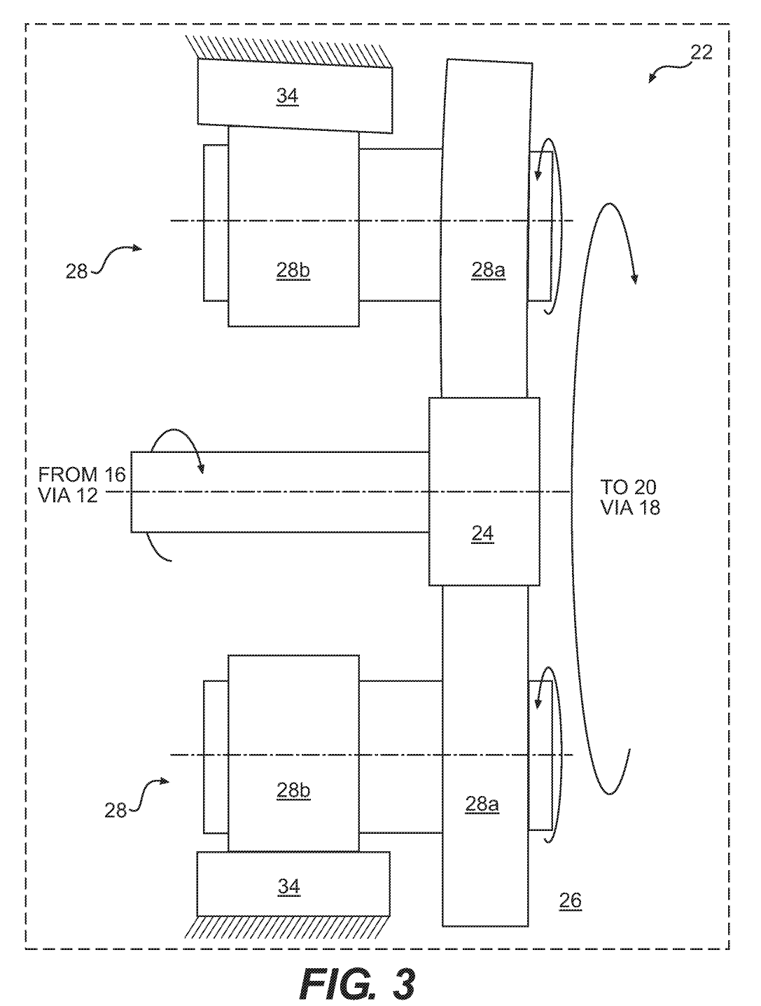

In the exemplary embodiment of FIG. 2, planetary gear arrangement 22 includes a single sun gear 24, a planet carrier 26 encapsulating four double-step planet gears 28, and a single ring gear 30 all disposed within a center housing 32. Sun gear 24 may be driven by differential 12. Each ring gear 30 may be held stationary within housing 32 (e.g., via a toothed or splined interface 34). Planet gears 28 may be connected to rotate with planet carrier 26 about a central axis 36 and to also rotate about their own axes 38. A larger diameter step 28a of each planet gear 28 may mesh with external teeth of sun gear 24, while a smaller diameter step 28b of each planet gear 28 may mesh with internal teeth of ring gear 30. Planet carrier 26 may be connected to rotate output member 18 (referring to FIG. 1). Thus, as shown in FIG. 3, the motion and power of input member 16 may be transmitted through differential 12 to output member 18 and traction device 20 via sun gear 24, planet gears 28 (only two shown in FIG. 3 for clarity), and planet carrier 26, with fixed ring gear 30 only affecting the reduction ratio of the motion.

As further illustrated in FIG. 2, planet carrier 26 may be a sub-assembly of multiple components that together support the rotation of planet gears 28. In particular, planet carrier may include a base 26a that is removably connectable to a hub 26b. Both of base 26a and hub 26b may be generally cylindrical and aligned with each other along axis 36. An axial end face 40 of base 26a may be configured to abut a corresponding axial end face 42 of hub 26b, after one or more alignment dowels 44 are inserted into corresponding bores 46 in each component of planet carrier 26. In one embodiment, bores 46 may be arranged in an offset pattern, such that only one assembly orientation is possible. Dowels 44 may be configured to carry torque loading between base 26a and hub 26b. Any number of fasteners 48 (e.g., four) may be used to axially secure hub 26b to base 26a. Fasteners 48 may pass through dowels 44 and engage corresponding threaded features (not shown) within base 26a.

Each of base 26a and hub 26b may include four bearing bores 50, which are each configured to receive a corresponding cylindrical bearing 52. Each bearing bore 50 (and bearing 52, after assembly) in base 26a may be axially aligned with a paired bearing bore 50 (and bearing 52, after assembly) in hub 26b. Each pair of aligned bearings 52 may be configured to receive a corresponding planet gear 28 therebetween. For example, a shaft 54 may extend from opposing axial ends of each planet gear 28 and be received by a corresponding pair of bearings 52, such that steps 28a and 28b of each planet gear 28 are sandwiched between and rotationally supported by bearings 52. Accordingly, planet gears 28 may be held inside of planet carrier 26 by way of shafts 54, bearings 52, and bearing bores 50.

Clearance openings 58 may be formed within base 26a of planet carrier 26 to accommodate sun gear 24 and planet gears 28. For example, a single centralized clearance opening 56 may be provided for sun gear 24, and four clearance openings 58 may be provided for the four planet gears 28 around clearance opening 56. Clearance opening 56 in base 26a may be stepped, having a larger diameter adjacent where sun gear 24 resides after assembly and a smaller diameter located axially closer to hub 26b. The smaller diameter of clearance opening 56 may be configured to internally receive a hollow cylindrical protrusion 60 of hub 26b, which functions as a splined-connector for output member 18 (referring to FIG. 1). Each clearance opening 58 may also be stepped, having a larger diameter adjacent the larger diameter step 28a of a corresponding planet gear 28 and a smaller diameter adjacent the smaller diameter step 28b. Surrounding portions of base 26a may extend axially a distance about equal to an axial length of planet gears 28. With this configuration, base 26a may resemble a spoked wheel, having four spokes that separate planet gears 28 from each other.

Sun gear 24, planet carrier 26, planet gears 28, ring gear 30, and bearings 52 may all be sub-assembled prior to insertion within housing 32. The sub-assembly may be supported within housing 32 only by way of interface 34 between ring gear 30 and housing 32. During assembly, ring gear 30 may be axially located and/or retained in place relative to the remaining components by way of base 26a and hub 26b. That is, base 26a and hub 26b may form axial movement boundaries at opposing sides of ring gear 30. After connection to differential 12 and output member 18 (referring to FIG. 1), the sub-assembly may be further supported by way of the connection of sun gear 24 with differential 12 and the connection of protrusion 60 with output member 18. Housing 32 may be bolted and/or welded in place between a housing of differential 12 and a housing (a.k.a., a leg housing) of output member 18.

### INDUSTRIAL APPLICABILITY

The drive assembly of the present disclosure may be applicable to any drivetrain having a planetary gear assembly where a high-reduction of speed is required within the confines of a small space. The high-reduction of speed may be provided within a small space by using four planet gears, each having a stepped profile. In the disclosed embodiment, the speed reduction is about 7:1.

The disclosed drive assembly may also provide increased durability. In particular, by supporting each of the disclosed planet gears at opposing ends (i.e., rather than using needle bearings that are located radially inward on a separate shaft), the support may experience reduced moments. In addition, the location of the bearings at axial ends of the planet gears may allow for large-diameter bearings. The reduced moments, combined with the large diameter bearings, may provide for the increased durability.

It will be apparent to those skilled in the art that various modifications and variations can be made to the drive assembly of the present disclosure without departing from the scope of the disclosure. Other embodiments will be apparent to those skilled in the art from consideration of the specification and practice of the drivetrain disclosed herein. For example, although ring gear 30 is shown and described as being stationary, it is contemplated that ring gear 30 could be free to rotate in particular applications, if desired. It is intended that the specification and examples be considered as exemplary only, with a true scope of the disclosure being indicated by the following claims and their equivalents.

What is claimed is:

1. A final drive, comprising:
a sun gear;
a ring gear;
a plurality of planet gears each having a large diameter portion configured to engage external teeth of the sun gear, and a small diameter portion configured to engage internal teeth of the ring gear;
a planet carrier operatively connected to each of the plurality of planet gears; and
a plurality of bearings disposed within the planet carrier and configured to support opposing ends of the plurality of planet gears.

2. The final drive of claim 1, further including a stationary housing configured to engage and support the ring gear.

3. The final drive of claim 1, wherein the planet carrier includes:
a base;
a hub; and
a plurality of fasteners connecting the hub to the base.

4. The final drive of claim 3, further including at least one alignment dowel extending from the base into the hub.

5. The final drive of claim 4, wherein at least one of the plurality fasteners passes from the hub through the at least one alignment dowel and into the base.

6. The final drive of claim 3, wherein the sun gear includes a shaft extending through the base in a direction away from the hub of the planet carrier.

7. The final drive of claim 3, wherein each of the base and hub include bearing bores configured to receive the plurality of bearings.

8. The final drive of claim 3, wherein the hub includes a protrusion extending inward toward the base and having a splined interface.

9. The final drive of claim 3, wherein the sun gear, the plurality of planet gears, the ring gear, and the plurality of bearings are located axially between the base and the hub.

10. The final drive of claim 3, wherein the hub includes clearance openings configured to provide space around the sun gear and the plurality of planet gears.

11. The final drive of claim 10, wherein the clearance openings include planet gear openings, each having a large diameter adjacent the large diameter portion of a corresponding one of the plurality of planet gears, and a small diameter adjacent the small diameter portion.

12. The final drive of claim 10, wherein the clearance openings include a center opening having a large diameter adjacent the sun gear, and a small diameter located axially closer to the hub.

13. The final drive of claim 10, wherein the base extends an axial distance about equal to an axial length of the plurality of planet gears.

14. The final drive of claim 1, wherein the plurality of planet gears includes four planet gears.

15. The final drive of claim 1, wherein the plurality of bearings are cylindrical bearings.

16. A final drive, comprising:
a sun gear;
a ring gear;
at least four planet gears each having a large diameter portion configured to engage external teeth of the sun gear, and a small diameter portion configured to engage internal teeth of the ring gear;
a planet carrier operatively connected to each of the at least four planet gears, the planet carrier having a base, a hub, and at least one fastener configured to connect the hub to the base; and
a plurality of bearings disposed within the base and the hub of the planet carrier and configured to support the at least four planet gears.

17. The final drive of claim 16, further including a stationary housing configured to engage and support the ring gear.

18. The final drive of claim 16, further including at least one alignment dowel extending from the base into the hub, wherein the at least one fasteners passes from the hub through the at least one alignment dowel and into the base.

19. The final drive of claim 16, wherein the sun gear, the at least four planet gears, the ring gear, and the plurality of bearings are located axially between the base and the hub of the planet carrier.

20. A drive assembly, comprising:
a differential having an input member;
a traction device;
an output member operatively connected to the traction device; and
a final drive connected between the differential and the output member, the final drive including:
a sun gear having a shaft connected to the differential;
a stationary ring gear;
at least four planet gears each having a large diameter portion configured to engage external teeth of the sun gear, and a small diameter portion configured to engage internal teeth of the stationary ring gear;
a planet carrier operatively connected to each of the at least four planet gears, the planet carrier having a base, a hub operatively connected to the output member, and at least one fastener configured to connect the hub to the base; and
a plurality of cylindrical bearings disposed within the base and the hub of the planet carrier and configured to support opposing ends of the at least four planet gears, wherein the sun gear, the at least four planet gears, the stationary ring gear, and the plurality of bearings are located axially between the base and the hub of the planet carrier.
